(19) United States
(12) Patent Application Publication
(10) Pub. No.: US 2019/0169429 A1
(43) Pub. Date: Jun. 6, 2019

(54) MULTIFUNCTIONAL FLAME RETARDANT THERMOPLASTIC COMPOSITIONS FOR CONNECTED PERSONAL PROTECTIVE EQUIPMENT

(71) Applicant: SABIC GLOBAL TECHNOLOGIES B.V., Bergen op Zoom (NL)

(72) Inventors: Mohammad MONIRUZZAMAN, Exton, PA (US); Jung HOCHUL, Perry, OH (US)

(21) Appl. No.: 16/325,287

(22) PCT Filed: Aug. 15, 2017
(86) PCT No.: PCT/US2017/046888

§ 371 Date: Feb. 13, 2019

Related U.S. Application Data
(60) Provisional application No. 62/375,058, filed on Aug. 15, 2016.

(51) Int. Cl. C08L 69/00; C08L 83/10; C08K 5/521; C08K 5/00

(52) U.S. Cl. CPC C08L 69/00; C08L 83/10; C08L 2201/02; C08K 5/0041; C08K 5/005; C08K 5/521

(57) ABSTRACT

A thermoplastic composition includes: a polycarbonate polymer component; an intrinsically conductive/dissipative polymer or a blend thereof; a flame retardant; an antidripping agent; and an ultraviolet (UV) stabilizer. The thermoplastic composition may be colorable or dyeable. In an aspect, the thermoplastic compositions exhibit improved properties, including but not limited to flame retardancy, ultraviolet stability, temperature resistance, room temperature and low temperature impact properties, chemical resistance, electrostatic dissipative capability and radio transmission capability. Articles formed from the thermoplastic composition include personal protective equipment such as helmets. Methods for forming the thermoplastic compositions and articles formed therefrom are also described.

### FIELD OF THE DISCLOSURE

The present disclosure relates to flame retardant thermoplastic compositions, and in particular flame retardant thermoplastic compositions that incorporate other features therein, including ultraviolet stability, temperature resistance, impact properties, chemical resistance, electrostatic dissipative capability and/or radio transmission capability.

### BACKGROUND OF THE DISCLOSURE

Personal protective equipment (PPE) such as safety helmets may include the capability to communicate real-time using audio and video transmission and safety features to work in the hazardous environments. Fabrication of these types of “smart” PPEs requires materials that possess multi-functionality. For example, to facilitate the communications the PPE may need to be transparent to radio frequencies, or to meet the ATEX Directive (94/9/EC) and/or EN 50014 in a potentially explosive atmosphere, the PPE may also need to have additional properties, such as ultraviolet (UV) stability, temperature resistance, impact properties, chemical resistance, flammability and electrostatic dissipative capability. Further, the Occupational Safety and Health Act (OSHA) may require that an industry color-code its safety protective equipment, which means the PPE must be colorable.

It is challenging to create materials with such multifunctional capability as many of the property requirements negatively affect each other. For example, electrostatic discharge (ESD) safe thermoplastic materials typically include black/grey conductive fillers, such as carbon fiber, carbon black or stainless steel fibers, that are difficult to color. Moreover, stainless steel fibers negatively affect radio frequency signal transmission. Colorable conductive technologies for thermoplastic compounds, e.g., intrinsically conductive/dissipative polymer blends, provide limited improvements in electrical conductivity, with typical conductivities in the range of 10¹⁰ to 10¹² ohms per square (Ω/sq). This falls in the antistatic range, as compared to the ESD range of 10⁶ to 10⁹ Ω/sq. Intrinsically conductive/dissipative polymer blends, however, negatively impact the flammability, impact and flow performance of the PPE materials. These and other shortcomings are addressed by aspects of the present disclosure.

### SUMMARY

Aspects of the disclosure relate to thermoplastic compositions that include: a thermoplastic polymer or a blend thereof; an intrinsically conductive/dissipative polymer or a blend thereof; a flame retardant; an antidripping agent; and an ultraviolet (UV) stabilizer. The thermoplastic compositions may be colorable or dyeable. In an aspect, the thermoplastic compositions exhibit improved properties, including but not limited to flame retardancy, ultraviolet stability, temperature resistance, room temperature (e.g., about 23° C.), and low temperature (e.g., about −25°) impact properties, chemical resistance, electrostatic dissipative capability, and/or radio transmission capability.

In further aspects, the present disclosure relates to an electrostatic dissipative thermoplastic composition comprising: a polycarbonate polymer component comprising a polycarbonate resin, a polysiloxane-polycarbonate copolymer, and a brominated polycarbonate resin; an intrinsically conductive or dissipative polymer or a blend thereof, wherein the intrinsically conductive or dissipative polymer has a surface resistivity less than or equal to 10⁷ ohms per square (ohm/sq); a flame retardant; an antidripping agent; and an ultraviolet (UV) stabilizer, wherein the thermoplastic composition is colorable or dyeable.

In yet further aspects, the present disclosure relates to an electrostatic dissipative thermoplastic composition comprising: a polycarbonate polymer component containing a polycarbonate resin, a polysiloxane-polycarbonate copolymer, and a brominated polycarbonate resin; an intrinsically conductive or dissipative polymer or a blend thereof, wherein the intrinsically conductive or dissipative polymer has a surface resistivity less than or equal to 10⁷ ohms per square (ohm/sq); a flame retardant; an antidripping agent; and an ultraviolet (UV) stabilizer, wherein the thermoplastic composition is colorable or dyeable.

The present disclosure relates to an electrostatic dissipative thermoplastic composition comprising: a polycarbonate polymer component containing a polycarbonate resin, a polysiloxane-polycarbonate copolymer, and a brominated polycarbonate resin; an intrinsically conductive or dissipative polymer or a blend thereof, wherein the intrinsically conductive or dissipative polymer has a surface resistivity less than or equal to 10⁷ ohms per square (ohm/sq); a flame retardant; an antidripping agent; a catalyst deactivator, and an ultraviolet (UV) stabilizer, wherein the thermoplastic composition is colorable or dyeable.

Aspects of the disclosure further relate to methods for making a thermoplastic composition, comprising: combining a thermoplastic polymer, an antidripping agent, an ultraviolet (UV) stabilizer, and optionally a colorant or dye to form a mixture; adding the mixture at a feed throat of an extruder and compounding the mixture in the extruder; adding an intrinsically conductive/dissipative polymer to the mixture at either the feed throat of the extruder or downstream in the extruder; adding a liquid flame retardant to the mixture downstream in the extruder through a liquid feed port in the extruder; and extruding the mixture to form the thermoplastic composition.

### DETAILED DESCRIPTION

The present disclosure can be understood more readily by reference to the following detailed description of the disclosure and the examples included therein. In various aspects, the present disclosure pertains to thermoplastic compositions including a polycarbonate polymer component; an intrinsically conductive polymer or a blend thereof; a flame retardant; an antidripping agent; and an ultraviolet (UV) stabilizer. The thermoplastic composition is colorable or dyeable. In an aspect, the thermoplastic compositions exhibit improved properties, including but not limited to flame retardancy, ultraviolet stability, temperature resistance, room temperature and low temperature impact properties, chemical resistance, electrostatic dissipative capability, and/or radio transmission capability.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim. Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate polymer” includes mixtures or blends of two or more polycarbonate polymers. As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optional impact modifier” means that the impact modifier can or cannot be included and that the description includes thermoplastic compositions in which the impact modifier is included and is not included.

As used herein, the term “effective amount” refers to an amount that is sufficient to achieve the desired modification of a physical property of the composition or material. For example, an “effective amount” of a mold release component refers to an amount that is sufficient to achieve the desired improvement in the property modulated by the formulation component, e.g., allowing the thermoplastic composition or article formed therefrom to be released from a mold.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B—F, C-D, C-E, and C—F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Certain abbreviations are defined as follows: “g” is grams, “kg” is kilograms, “° C.” is degrees Celsius, “° F.” is degrees Fahrenheit, “min” is minutes, “mm” is millimeter, “mPa” is megapascal, “WiFi” is a system of accessing the internet from remote machines, “GPS” is Global Positioning System—a global system of U.S. navigational satellites which provide positional and velocity data. “LED” is light-emitting diode, “RF” is radio frequency, and “RFID” is radio frequency identification.

Unless otherwise stated to the contrary herein, all test standards are the most recent standard in effect at the time of filing this application. Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Thermoplastic Compositions

Aspects of the disclosure relate to a thermoplastic composition, particularly an electrostatic dissipative thermoplastic composition, including: a thermoplastic polymer or a blend thereof; an intrinsically conductive or dissipative polymer or a blend thereof; c. a flame retardant; d. an antidripping agent; and e. an ultraviolet (UV) stabilizer, wherein the thermoplastic composition is colorable or dyeable. In certain aspects, the thermoplastic polymer comprises a polycarbonate polymer. The electrostatic dissipative thermoplastic composition may comprise a polycarbonate polymer comprising a polycarbonate resin, a polysiloxane-polycarbonate copolymer, and a brominated polycarbonate resin; an intrinsically conductive or dissipative polymer or a blend thereof, wherein the intrinsically conductive or dissipative polymer has a surface resistivity less than or equal to 107 ohm/sq; a flame retardant; an antidripping agent; and an ultraviolet (UV) stabilizer, wherein the thermoplastic composition is colorable or dyeable.

### Thermoplastic Polymer

In certain aspects of the present disclosure, the disclosed electrostatic dissipative thermoplastic composition comprises a polycarbonate polymer. As used herein, polycarbonate refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates. In particular aspects, the polycarbonate includes an aromatic polycarbonate, a polycarbonate copolymer, a polycarbonate-siloxane copolymer, a polycarbonate-ether copolymer, a brominated polycarbonate copolymer or a combination thereof.

According to various examples of the present disclosure, the polycarbonate polymer may comprise comprising a polycarbonate resin, a polysiloxane-polycarbonate copolymer, or a brominated polycarbonate resin, or a combination thereof. The brominated polycarbonate resin may include repeating units derived from bisphenol-A and tetrabromobisphenol-A. In certain aspects, the brominated polycarbonate may contain repeating units derived from the tetrabromobisphenol-A in an amount such that the polycarbonate contains from about 5 wt % to about 30 wt % of bromine. A specific example is a polycarbonate polymer/oligomer containing brominated carbonate units derived from 2,2′,6,6′-tetrabromo-4,4′-isopropylidenediphenol (TBBPA) and carbonate units derived from a dihydroxy aromatic compound such as bisphenol-A.

Brominated polycarbonate oligomers are disclosed, for example, in U.S. Pat. Nos. 4,923,933, 4,170,711, and 3,929,908. Examples of brominated aromatic dihydroxy compounds include 2,2-bis(3,5-dibromo-4-hydroxyphenyl)propane, bis(3,5-dibromo-4-hydroxyphenyl)menthanone, and 2,2′,6,6′-tetramethyl-3,3′,5,5′-tetrabromo-4,4′-biphenol. Examples of non-brominated aromatic dihydroxy compounds for copolymerization with the brominated aromatic dihydroxy compounds include Bisphenol-A, bis(4-hydroxyphenyl) methane, 2, 2-bis(4-hydroxy-3-methylphenyl)propane, 4,4-bis(4-hydroxyphenyl)heptane, and (3,3′-dichloro-4,4′-dihydroxydiphenyl)methane. Combinations of two or more different brominated and non-brominated aromatic dihydroxy compounds can be used. Branched brominated polycarbonate oligomers can also be used, as can compositions of a linear brominated polycarbonate oligomer and a branched brominated polycarbonate oligomer. Combinations of different brominated copolycarbonate oligomers can be used. Various endcaps can be present, for example polycarbonates having phenol endcaps or 2,4,6-tribromophenol endcaps can be used.

Brominated polycarbonate oligomers are disclosed, for example, in U.S. Pat. Nos. 4,923,933, 4,170,711, and 3,929,908. Examples of brominated aromatic dihydroxy compounds include 2,2-bis(3,5-dibromo-4-hydroxyphenyl)propane, bis(3,5-dibromo-4-hydroxyphenyl)menthanone, and 2,2′,6,6′-tetramethyl-3,3′,5,5′-tetrabromo-4,4′-biphenol. Examples of non-brominated aromatic dihydroxy compounds for copolymerization with the brominated aromatic dihydroxy compounds include Bisphenol-A, bis(4-hydroxyphenyl) methane, 2, 2-bis(4-hydroxy-3-methylphenyl)propane, 4,4-bis(4-hydroxyphenyl)heptane, and (3,3′-dichloro-4,4′-dihydroxydiphenyl)methane. Combinations of two or more different brominated and non-brominated aromatic dihydroxy compounds can be used. If a combination of aromatic dihydroxy compounds is used, then the combinations can contain 25 to 55 mole percent of the brominated aromatic dihydroxy compounds and 75 to 65 mole percent of a non-brominated dihydric phenol. Branched brominated polycarbonate oligomers can also be used, as can compositions of a linear brominated polycarbonate oligomer and a branched brominated polycarbonate oligomer. Combinations of different brominated copolycarbonate oligomers can be used. Various endcaps can be present, for example polycarbonates having phenol endcaps or 2,4,6-tribromophenol endcaps can be used.

The brominated polycarbonate may contain brominated and non-brominated monomers in a ratio such that the polymer/oligomer contains from about 5 wt % to about 30 wt % of bromine, based on the total weight of the polymer/oligomer. An exemplary brominated polymer has a weight average molecular weight of about 23,660, a PDI of about 2.6, and a bromine content of 26%, and can be made using interfacial polymerization methods.

In some examples, the brominated polycarbonate resin may be present in an amount up to 50 wt. % of the total polycarbonate polymer component. More specifically, the brominated polycarbonate resin may be present in an amount from 8 wt. % to 50 wt. % of the total polycarbonate polymer component. Or, the brominated polycarbonate resin may be present in an amount from 10 wt. % to 50 wt. % of the total polycarbonate polymer component. The brominated polycarbonate resin may be present in exemplary amounts such as from about 10 wt. % or 10 wt. %, about 20 wt. % or 20 wt. %, about 25 wt. % or 25 wt. %, about 30 wt. % or 30 wt. %, about 35 wt. % or 35 wt. %, about 40 wt. % or 40 wt. %, to 50 wt. % of the total polycarbonate polymer component.

In further aspects, the thermoplastic polymer may comprise a polycarbonate polymer comprising a polycarbonate-polysiloxane copolymer. As used herein, the term “polycarbonate-polysiloxane copolymer” is equivalent to polysiloxane-polycarbonate copolymer, polycarbonate-polysiloxane polymer, or polysiloxane-polycarbonate polymer. In various aspects, the polycarbonate-polysiloxane copolymer can be a block copolymer comprising one or more polycarbonate blocks and one or more polysiloxane blocks. The polysiloxane-polycarbonate copolymer comprises polydiorganosiloxane blocks comprising structural units of the general formula (1) below:

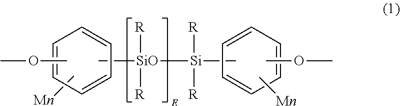

wherein the polydiorganosiloxane block length (E) is about 20 to about 60; wherein each R group can be the same or different, and is selected from a C₁₋₁₃ monovalent organic group; wherein each M can be the same or different, and is selected from a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂aralkoxy, C₇-C₁₂ alkylaryl, or C₇-C₁₂ alkylaryloxy, and where each n is independently 0, 1, 2, 3, or 4. The polysiloxane-polycarbonate copolymer also comprises polycarbonate blocks comprising structural units of the general formula (2) below:

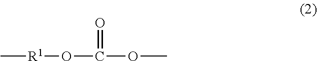

wherein at least 60 percent of the total number of R¹ groups comprise aromatic moieties and the balance thereof comprise aliphatic, alicyclic, or aromatic moieties. Polysiloxane-polycarbonates materials include materials disclosed and described in U.S. Pat. No. 7,786,246, which is hereby incorporated by reference in its entirety for the specific purpose of disclosing various compositions and methods for manufacture of same.

In one aspect, the polysiloxane-polycarbonate copolymer can comprise 10 wt % or less, specifically 6 wt % or less, and more specifically 4 wt % or less, of the polysiloxane based on the total weight of the polysiloxane-polycarbonate copolymer, and can generally be optically transparent and are commercially available under the designation EXL-T from SABIC. In another aspect, the polysiloxane-polycarbonate copolymer can comprise 10 wt % or more, specifically 12 wt % or more, and more specifically 14 wt % or more, of the polysiloxane copolymer based on the total weight of the polysiloxane-polycarbonate copolymer, are generally optically opaque and are commercially available under the trade designation EXL-P from SABIC.

Polyorganosiloxane-polycarbonates can have a weight average molecular weight of 2,000 Daltons to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards.

The polyorganosiloxane-polycarbonates can have a melt volume flow rate, measured at 300° C./1.2 kg, of 1 to 50 cubic centimeters per 10 minutes (cm³/10 min), specifically 2 to 30 cm³/10 min. Mixtures of polyorganosiloxane-polycarbonates of different flow properties can be used to achieve the overall desired flow property.

Non-limiting examples of polysiloxane-polycarbonate copolymers can comprise various copolymers available from SABIC Innovative plastics. In an aspect, the polysiloxane-polycarbonate copolymer can contain 6% by weight polysiloxane content based upon the total weight of the polysiloxane-polycarbonate copolymer. In various aspects, the 6% by weight polysiloxane block copolymer can have a weight average molecular weight (Mw) of from about 23,000 to 24,000 Daltons using gel permeation chromatography with a bisphenol A polycarbonate absolute molecular weight standard. In certain aspects, the 6% weight siloxane polysiloxane-polycarbonate copolymer can have a melt volume flow rate (MVR) of about 10 cm³/10 min at 300° C./1.2 kg (see C9030T, a 6% by weight polysiloxane content copolymer available from SABIC Innovative Plastics as “transparent” Lexan™ EXL C9030T resin polymer). In another example, the polysiloxane-polycarbonate block can comprise 20% by weight polysiloxane based upon the total weight of the polysiloxane block copolymer. For example, an appropriate polysiloxane-polycarbonate copolymer can be a bisphenol A polysiloxane-polycarbonate copolymer endcapped with para-cumyl phenol (PCP) and having a 20% polysiloxane content (see C9030P, commercially available from SABIC as the “opaque” Lexan™ EXL C9030P). In various aspects, the weight average molecular weight of the 20% polysiloxane block copolymer can be about 29,900 Daltons to about 31,000 Daltons when tested according to a polycarbonate standard using gel permeation chromatography (GPC) on a cross-linked styrene-divinylbenzene column and calibrated to polycarbonate references using a UV-VIS detector set at 264 nm on 1 mg/ml samples eluted at a flow rate of about 1.0 ml/minute. Moreover, the 20% polysiloxane block copolymer can have a melt volume rate (MVR) at 300° C./1.2 kg of 7 cm³/10 min and can exhibit siloxane domains sized in a range of from about 5 micron to about 20 micrometers (microns, μm).

In some examples, the polysiloxane-polycarbonate copolymer may be present in an amount up to 80 wt. % of the total polycarbonate polymer component. More specifically, the polysiloxane-polycarbonate copolymer may be present in an amount from 1 wt. % to 80 wt. % or from about 1 wt. % to about 80 wt. % of the total polycarbonate polymer component. The brominated polycarbonate resin may be present in exemplary amounts such as from about 10 wt. % or 10 wt. %, about 20 wt. % or 20 wt. %, about 25 wt. % or 25 wt. %, about 30 wt. % or 30 wt. %, about 35 wt. % or 35 wt. %, about 40 wt. % or 40 wt. %, about 45 wt. % or 45 wt. %, about 50 wt. % or 50 wt. %, about 55 wt. % or 55 wt. %, about 60 wt. % or 60 wt. %, about 65 wt. % or 65 wt. %, about 70 wt. % or 70 wt. %, about 75 wt. % or 75 wt. %, up to 80 wt. % of the total polycarbonate polymer component.

In certain aspects, the thermoplastic polymer may be present in the thermoplastic composition in an amount of from about 40 wt % to about 90 wt %. In other aspects the thermoplastic polymer may be present in the thermoplastic composition in an amount of from about 50 wt % to about 84 wt %, or from about 60 wt % to about 78 wt %. More specifically, the polycarbonate polymer component may be present from about 40 wt. % to about 90 wt. % based on the total weight of the thermoplastic composition (or electrostatic dissipative thermoplastic composition).

As provided above, the electrostatic dissipative thermoplastic composition comprises a polycarbonate polymer. The polycarbonate polymer may comprise a polycarbonate resin, a polysiloxane-polycarbonate copolymer, or a brominated polycarbonate resin, or a combination thereof.

In an example, the composition may comprise from about 40 wt % to about 85 wt % polycarbonate blend containing 1 −80 wt % of polysiloxane-polycarbonate copolymer and 10-50 wt % brominated polycarbonate based on the weight of the polycarbonate component; from about 5 wt % to about 50 wt % intrinsically conductive polymer; from about 3 wt % to about 25 wt % flame retardant; from about 0.1 wt % to about 5 wt % antidripping agent; from about 0.1 wt % to about 3 wt % UV stabilizer; and from about 0.1 wt % to about 10 wt % colorant or dye.

For example, the composition may comprise from about 40 wt % to about 85 wt % of a polycarbonate blend or component containing 1 −80 wt % of polysiloxane-polycarbonate copolymer and 10-50 wt % brominated polycarbonate based on the weight of the polycarbonate component; from about 5 wt % to about 50 wt % intrinsically conductive polymer based on the total weight of the composition; from about 3 wt % to about 25 wt % flame retardant based on the total weight of the composition; from about 0.1 wt % to about 5 wt % antidripping agent based on the total weight of the composition; from about 0.1 wt % to about 3 wt % UV stabilizer; and from about 0.1 wt % to about 10 wt % colorant or dye based on the total weight of the composition.

In further examples, the composition may comprise from about 40 wt % to about 85 wt % polycarbonate blend containing 1 −80 wt % of polysiloxane-polycarbonate copolymer and 8-50 wt % brominated polycarbonate based on the weight of the polycarbonate component; from about 5 wt % to about 50 wt % intrinsically conductive polymer; from about 3 wt % to about 25 wt % flame retardant; from about 0.1 wt % to about 5 wt % antidripping agent; from about 0.1 wt % to about 3 wt % UV stabilizer; and from about 0.1 wt % to about 10 wt % colorant or dye.

### Intrinsically Conductive Polymer

Compositions of the present disclosure may include an intrinsically conductive or dissipative polymer. The term “intrinsically conductive/dissipative polymers” refers to several polymeric materials that are inherently conductive or static dissipative and can be melt processed with electrically insulative polymers to improve the conductive properties of the later. Examples of intrinsically conductive/dissipative polymers include: copolyesteramides such as those disclosed in U.S. Pat. No. 4,115,475 to Foy et al., U.S. Pat. Nos. 4,839,441 and 4,864,014 to CuZin et al.; polyether-polyamide (polyetheramide) block copolymers such as those disclosed in U.S. Pat. No. 5,840,807 to Frey et al.; polyetheresteramide block copolymers such as those disclosed in U.S. Pat. Nos. 5,604,284; 5,652,326; and U.S. Pat. No. 5,886,098 to Ueda et al., U.S. Pat. Nos. 4,331,786; 4,230,838; 4,332,920 to Foy et al., and U.S. Pat. No. 4,195,015 to Deleens et al.; polyurethanes containing a polyalkylene glycol moiety such as those disclosed in U.S. Pat. No. 5,159,053 to Kolycheck et al., and U.S. Pat. No. 5,863,466 to Mor et al.; polyetheresters such as those disclosed in U.S. Pat. Nos. 5,112,940, 4,537,596 to Muller et al., and U.S. Pat. No. 4,038,258 to Singh et al, all of which are incorporated herein by reference in their entirety.

Intrinsically conductive/dissipative polymers have been shown to be fairly thermally stable and processable in the melt state in their neat form or in blends with other polymeric resins. Examples of polyetheramides, polyetheresters and polyetheresteramides include block copolymers and graft copolymers both obtained by the reaction between a polyamide-forming compound and/or a polyester-forming compound, and a compound containing a polyalkylene oxide unit. Polyamide forming compounds include aminocarboxylic acids such as ω-aminocaproic acid, uu-aminoenanthic acid, ω-aminocaprylic acid, ω-aminopelargonic acid, ω-aminocapric acid, 11-aminoundecanoic acid and 12-aminododecanoic acid; lactams such as ε-caprolactam and enanthlactam; a salt of adiamine With a dicarboxylic acid, such as hexamethylene diamine adipate, hexamethylene diamine sebacate, and hexamethylene diamine isophthalate; and a mixture of these polyamide-forming compounds. In one example, the polyamide-forming compound is a caprolactam, 12-aminododecanoic acid, or a combination of hexamethylene diamine and adipate. Polyester forming compounds include a combination of a dicarboxylic acid (or a mixture of two or more dicarboxylic acids) with an aliphatic diol (or a mixture of two or more aliphatic diols). Non-limiting examples of dicarboxylicacids include aromatic dicarboxylic acids, such as isophthalic acid, terephthalic acid, phthalic acid, naphthalene-2, 6-dicarboxylic acid, naphthalene-2,7-dicarboxylic acid, diphenyl-4,4′-dicarboxylic acid, diphenoxyethane dicarboxylic acid and sodium sulfoisophthalate; alicyclic dicarboxylic acids, such as 1,3-cyclopentanedicarboxylic acid, 1,4 cyclohexanedicarboxylic acid, 1,2-cyclohexanedicarboxylic acid and 1,3-dicarboxymethylcyclohexane; and aliphatic dicarboxylic acids, such as succinic acid, oxalic acid, adipic acid, sebacic acid and decanedicarboxylic acid. These dicarboxylic acids may be used individually or in combination. Non-limiting examples of aliphatic diols include ethylene glycol, 1,2-propylene glycol, 1,3-propylene glycol, 1,2-butanediol, 1,3-butanediol, 2,3-butanediol, 1,4-butanediol, neopentyl glycol and hexanediol. These aliphatic diols may be used individually or in combination. Preferred dicarboxylic acids are terephthalic acid, isophthalic acid, 1,4-cyclohexanedicarboxylic acid, and sebacic acid and decanedicarboxylic acid. Preferred diols are ethylene glycol, 1,2-propylene glycol, 1,3-propylene glycol and 1,4-butanediol. Compounds containing polyalkylene oxide units such as polyethylene glycol, polypropylene glycol, polytetramethylene glycol and a block or random copolymer of ethylene oxide and tetramethylene oxide; diamines obtained by replacing the terminal hydroxyl groups of these diols by amino groups; and dicarboxylic acids obtained by replacing the terminal hydroxyl groups of these diols by carboxylic acid groups can be used to form the polyetheramide, polyetherester and polyetheresteramide polymeric antistatic agents. These compounds containing a polyalkylene oxide unit can be used individually or in combination. Of these compounds, polyethylene glycol is preferred. For synthesizing a polyetheramide, a polyetherester or a polyetheresteramide, there can be employed a method in which a polyamide-forming compound and/or a polyester forming compound is reacted with a polyalkylene oxide unit-containing compound, Wherein, depending on the type of the terminal groups of the polyalkylene oxide unit containing compound, the reaction is an esterifcation reaction or an amidation reaction. Further, depending on the type of the reaction, a dicarboxylic acid or a diamine may also be used in the reaction.

Intrinsically conductive/dissipative polymers such as, Pelestat™ 6321, available from Sanyo, or Pebax™ MH1657, available from Arkema, are non-limiting examples of commercially available intrinsically conductive/dissipative polymer that may be added to other polymeric resins to improve conductive properties. Other commercially available intrinsically conductive/dissipative polymers are Irgastat™ P18 and P22 from Ciba-Geigy. Other polymeric materials that may be used as intrinsically conductive/dissipative polymers are doped inherently conducting polymers such as polyaniline (commercially available as Panipol™ EB from Panipol), polypyrrole and polythiophene (commercially available from Bayer), which retain some of their intrinsic conductivity after melt processing at elevated temperatures.

In one example, the intrinsically conductive/dissipative polymer is used in an amount greater than or equal to about 5 wt %. In further examples the intrinsically conductive/dissipative polymer is present in an amount greater or equal to about 8. The intrinsically conductive/dissipative polymer may be present in an amount up to 15 wt % of the total composition.

As an example, the intrinsically conductive/dissipative polymer has a surface resistivity less than or equal to 10⁷ ohm/sq. Non-limiting example of commercially available conductive/dissipative polymers having surface resistivity less than or equal to 10⁷ ohm/sq include Pelectron™ AS from Sanyo and Pebax™ MF5010 from Arkema.

The intrinsically conductive polymer may be present in the thermoplastic composition in an amount of from about 5 wt % to about 50 wt %. In other aspects the intrinsically conductive polymer may be present in the thermoplastic composition in an amount of from about 10 wt % to about 30 wt %, or from about 15 wt % to about 25 wt %.

### Flame Retardant

The composition of the present disclosure may include a flame retardant additive or component. The electrostatic dissipative composition may also comprise at least one flame retardant, generally a halogenated material, an organic phosphate, or a combination of the two. For antistatic compositions containing polyphenylene ether or a polycarbonate resin, the organic phosphate classes of materials are generally preferred. The organic phosphate is preferably an aromatic phosphate compound of the formula (3):

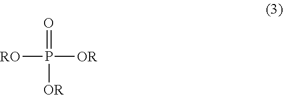

wherein each R is the same or different and is preferably an alkyl, a cycloalkyl, an aryl, an alkyl substituted aryl, a halogen substituted aryl, an aryl substituted alkyl, a halogen, or a combination of at least one of the foregoing phosphate compounds provided at least one R is aryl.

Examples of suitable phosphate compounds include phenyl bis(dodecyl) phosphate, phenyl bis(neopentyl) phosphate, phenyl bis(3,5,5′-trimethylhexyl phosphate), ethyl diphenyl phosphate, 2-ethylhexyl bis(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, tricresyl phosphate, triphenyl phosphate, dibutylphenyl phosphate, 2-chloroethyl diphenyl phosphate, p-tolyl bis(2,5,5′-trimethylhexyl) phosphate, 2-ethylhexyl diphenyl phosphate, and the like. The preferred phosphates are those in which each R is aryl. A preferred phosphate compound is triphenyl phosphate, which may be unsubstituted or substituted, for example, isopropylated triphenyl phosphate.

Alternatively, the organic phosphate can be a di- or polyfunctional compound or polymer having the formula (4), (5), or (6) below:

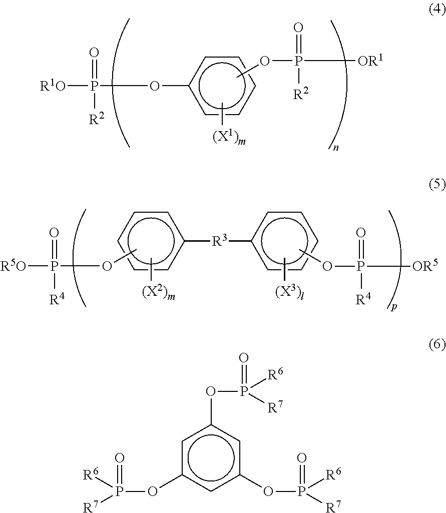

including mixtures thereof, in which R1, R3 and R5 are independently hydrocarbon; R2, R4, R6 and R7 are independently hydrocarbon or hydrocarbonoxy; X1, X2 and X3 are halogen; m and r are 0 or integers from 1 to 4, and n and p are integers from 1 to 30.

Examples of di- and polyfunctional phosphate compounds include the bis (diphenyl phosphates) of resorcinol, hydroquinone and bisphenol-A, respectively, or their polymeric counterparts. Methods for the preparation of the aforementioned di- and polyfunctional phosphates are described in British Patent No. 2,043,083. Another group of useful flame-retardants include certain cyclic phosphates, for example, diphenyl pentaerythritol diphosphate, as a flame retardant resin for polyphenylene ether resins, as is described by Axelrod in U.S. Pat. No. 4,254,775.

The flame retardant composition may contain a single phosphate compound or a mixture of two or more different types of phosphate compounds. Compositions containing essentially a single phosphate compound are preferred. Exemplary phosphate flame-retardants include those based upon resorcinol such as, for example, resorcinol bis(diphenyl phosphate), as Well as those based upon bisphenols such as, for example, bisphenol A bis(diphenyl phosphate). Also preferred are the aforementioned piperaZine-type phosphoramides. Phosphates containing substituted phenyl groups are also preferred. In an exemplary aspect, the organophosphate is butylated triphenyl phosphate ester. The most preferred phosphate compounds are resorcinol bis (diphenyl phosphate) (hereinafter RDP), bisphenol A bis (diphenyl phosphate) (hereinafter BPADP) and N,N′-bis[di(2,6-xylyl)phosphoryl]-piperaZine (hereinafter XPP), and mixtures thereof.

In some aspects, it may be desired to have flame retardant compositions that are essentially free of halogen atoms, especially bromine and chlorine. Essentially free of halogen atoms means that in some aspects the composition has less than about 3% halogen by weight of the composition and in other aspects less than about 1% by weight of the composition containing halogen atoms. The amount of halogen atoms can be determined by ordinary chemical analysis.

The flame retardant may also optionally include a fluoropolymer, which may be used in any effective amount to provide anti-drip properties to the resin composition. Some possible examples of suitable fluoropolymers and methods for making such fluoropolymers are set forth, for example, in U.S. Pat. Nos. 3,671,487, 3,723,373 and 3,383,092, the entire disclosures of which are incorporated herein by this reference. Suitable fluoropolymers include homopolymers and copolymers that comprise structural units derived from one or more fluorinated alpha-olefin monomers. The term “fluorinated alpha-olefin monomer” means an alpha-olefin monomer that includes at least one fluorine atom substituent. Some of the suitable fluorinated alpha-olefin monomers include, for example, fluoro ethylenes such as, for example, CF₂═CF₂, CHF═CF₂, CH₂═CF₂ and CH₂═CHF and fluoro propylenes such as, for example, CF₃CF═CF₂, CF₃CF═CHF, CF₃CH═CF₂, CF₃CH═CH₂, CF₃CF═CHF, CHF₂CH═CHF and CF₃CF═CH₂.

Some of the suitable fluorinated alpha-olefin copolymers include copolymers comprising structural units derived from two or more fluorinated alpha-olefin monomers such as, for example, poly(tetrafluoro ethylene-hexafluoro ethylene), and copolymers comprising structural units derived from one or more fluorinated monomers and one or more non-fluorinated monoethylenically unsaturated monomers that are copolymerizable with the fluorinated monomers such as, for example, poly(tetrafluoroethylene-ethylene-propylene) copolymers. Suitable non-fluorinated monoethylenically unsaturated monomers include for example, alpha-olefin monomers such as, for example, ethylene, propylene, butene, acrylate monomers such as for example, methyl methacrylate, butyl acrylate, and the like, with poly(tetrafluoroethylene) homopolymer (PTFE) preferred.

In particular aspects the flame retardant comprises phosphazene, aryl phosphate, bisphenol A diphosphate, resorcinol bis-diphenylphosphate, bisphenol A diphenyl phosphate, resorcinol diphosphate, or a combination thereof.

In some aspects the flame retardant is a liquid flame retardant, which could be added with the other components of the thermoplastic composition at any time during its manufacture. In a particular aspect in which the thermoplastic composition is formed from an extrusion process, a liquid flame retardant may be added into the extruder containing the other components downstream in the extruder through a liquid feed port in the extruder.

In certain aspects the flame retardant may be present in the thermoplastic composition in an amount of from about 3 wt % to about 25 wt %. In other aspects the flame retardant may be present in the thermoplastic composition in an amount of from about 5 wt % to about 20 wt %, or from about 5 wt % to about 10 wt %.

### Antidripping Agent

The antidripping agent (also referred to as an “anti-drip agent”) according to aspects of the disclosure may include a fluoropolymer, specifically a fluorinated polyolefin, which reduces the tendency of the material to produce burning drips in case of flame. Fluorinated polyolefins are known and are described, for example, in EP0640655, incorporated herein by this reference in its entirety. They are marketed, for example, by DuPont under the trademark Teflon™ 30N. Fluoropolymers suitable for use as the fluoropolymer component can be fibrillated (“fibrillatable”). “Fibrillation” is a term of art that refers to the treatment of fluoropolymers so as to produce, for example, a “node and fibril,” network, or cage-like structure. Suitable fluoropolymers include but are not limited to homopolymers and copolymers that comprise structural units derived from one or more fluorinated alpha-olefin monomers, that is, an alpha-olefin monomer that includes at least one fluorine atom in place of a hydrogen atom. In one aspect the fluoropolymer comprises structural units derived from two or more fluorinated alpha-olefin, for example tetrafluoroethylene, hexafluoroethylene, and the like. In an aspect, the fluoropolymer comprises structural units derived from one or more fluorinated alpha-olefin monomers and one or more non-fluorinated monoethylenically unsaturated monomers that are copolymerizable with the fluorinated monomers, for example alpha-monoethylenically unsaturated copolymerizable monomers such as ethylene, propylene, butene, acrylate monomers (e.g., methyl methacrylate and butyl acrylate), vinyl ethers, (e.g., cyclohexyl vinyl ether, ethyl vinyl ether, n-butyl vinyl ether, vinyl esters) and the like. Specific examples of fluoropolymers include poly(tetrafluoroethylene), poly(hexafluoropropylene), poly(vinylidene fluoride), poly(chlorotrifluoroethylene), poly(ethylene-tetrafluoroethylene), fluorinated ethylene-propylene polymer, poly(vinyl fluoride), and poly(ethylene-chlorotrifluoroethylene). Combinations comprising at least one of the foregoing fluoropolymers can also be used.

In an aspect, the fluoropolymer is at least partially encapsulated by an encapsulating polymer that can be the same or different as the matrix polymer (hereinafter referred to as an “encapsulated polymer”). Specific encapsulating polymers include polystyrene, copolymers of polystyrene, poly(alpha-methylstyrene), poly(alpha-ethylstyrene), poly(alpha-propylstyrene), poly(alpha-butylstyrene), poly(p-methylstyrene), polyacrylonitrile, poly(methacrylonitrile), poly(methyl acrylate), poly(ethyl acrylate), poly(propyl acrylate), and poly(butyl acrylate), poly(methyl methacrylate), poly(ethyl methacrylate), poly(propyl methacrylate), poly(butyl methacrylate); polybutadiene, copolymers of polybutadiene with propylene, poly(vinyl acetate), poly(vinyl chloride), poly(vinylidene chloride), poly(vinylidene fluoride), poly(vinyl alcohols), acrylonitrile-butadiene copolymer rubber, acrylonitrile-butadiene-styrene (ABS), poly(C4-8 alkyl acrylate) rubbers, styrene-butadiene rubbers (SBR), EPDM rubbers, silicon rubber and combinations comprising at least one of the foregoing encapsulating polymers. In another aspect, the encapsulating polymer comprises SAN, ABS copolymers, alpha-(C1-3)alkyl-styrene-acrylonitrile copolymers, alpha-methylstyrene-acrylonitrile (AMSAN) copolymers, SBR, and combinations comprising at least one of the foregoing. In yet another aspect the encapsulating polymer is SAN or AMSAN.

In a specific aspect the encapsulated fluoropolymer is poly(tetrafluoroethylene) (PTFE) encapsulated by a styrene-acrylonitrile copolymer (SAN). Small amounts of other fluoropolymers can be used, for example those comprising units derived from fluorinated monomers such as 3,3,3-trifluoropropene, 3,3,3,4,4-pentafluoro-1-butene, hexafluoropropylene, vinyl fluoride; vinylidene fluoride, 1,2-difluoroethylene, and the like, or a mixture comprising at least one of the foregoing monomers. Suitable amounts amount of encapsulating polymer can be determined by one of ordinary skill in the art without undue experimentation, using the guidance provided below. In one aspect, the encapsulated fluoropolymer comprises about 10 to about 90 wt. % (wt. %) fluoropolymer and about 90 to about 10 wt. % of the encapsulating polymer, based on the total weight of the encapsulated fluoropolymer. Alternatively, the encapsulated fluoropolymer comprises about 20 to about 80 wt. %, more specifically about 40 to about 60 wt. % fluoropolymer, and about 80 to about 20 wt. %, specifically about 60 about 40 wt. % encapsulating polymer, based on the total weight of the encapsulated polymer.

A useful encapsulated fluoropolymer is PTFE encapsulated in styrene-acrylonitrile (SAN), also known as TSAN. The SAN can comprise, for example, about 75 wt. % styrene and about 25 wt. % acrylonitrile based on the total weight of the copolymer. An exemplary TSAN comprises about 50 wt. % PTFE and about 50 wt. % SAN, based on the total weight of the encapsulated fluoropolymer.

In certain aspects the antidripping agent may be present in the thermoplastic composition in an amount of from about 0.1 wt % to about 5 wt % or from 0.1 wt. % to 5 wt. %. In other aspects the antidripping agent may be present in the thermoplastic composition in an amount of from about 0.5 wt. % to about 3 wt. % (or from 0.5 wt. % to 3 wt. %), or from about 1 wt % to about 2 wt % (or from 1 wt. % to 2 wt. %).

### Ultraviolet Stabilizer

The ultraviolet (UV) stabilizer can include any stabilizer, which when used in accordance with this disclosure, enables our composition (or an article derived from the composition) to exhibit a UV resistance of delta E (ΔE) ranging from more than 0 to less than or equal to 10 units after exposure to ultraviolet light for 300 hours, per ASTM D-4459 protocol. Examples of suitable UV stabilizers can include benzophenones, triazines, benzoxazinones, benzotriazoles, benzoates, formamidines, cinnamates/propenoates, aromatic propanediones, benzimidazoles, cycloaliphatic ketones, formanilides, cyanoacrylates, benzopyranones, salicylates, and combinations thereof.

UV absorbing additives include hydroxybenzophenones; hydroxybenzotriazoles; hydroxybenzotriazines; cyanoacrylates; oxanilides; benzoxazinones; aryl salicylates; monoesters of diphenols such as resorcinol monobenzoate; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); poly[(6-morphilino-s-triazine-2,4-diyl)[2,2,6,6-tetramethyl-4-piperidyl)i-mino]-hexamethylene[(2,2,6,6-tetramethyl-4-piperidyl)imino], 2-hydroxy-4-octyloxybenzophenone (UVINUL™ 3008), 6-tert-butyl-2-(5-chloro-2H-benzotriazole-2-yl)-4-methylphenyl (UVINUL™ 3026), 2,4-di-tert-butyl-6-(5-chloro-2H-benzotriazole-2-yl)-phenol(UVINUL™ 3027), 2-(2H-benzotriazole-2-yl)-4,6-di-tert-pentylphenol (UVINUL™ 3028), 2-(2H-benzotriazole-2-yl)-4-(1,1,3,3-tetramethylbutyl)-phenol (UVINUL™ 3029), 1,3-bis[(2′ cyano-3′,3′-diphenylacryloyl)oxy]-2,2-bis-{[(2′-cyano-3′,3′-diphenylacryl-oyl)oxy]methyl}-propane (UVINUL™ 3030), 2-(2H-benzotriazole-2-yl)-4-methylphenol (UVINUL™ 3033), 2-(2H-benzotriazole-2-yl)-4,6-bis(1-methyl-1-phenyethyl)phenol (UVINUL™ 3034), ethyl-2-cyano-3,3-diphenylacrylate (UVINUL™ 3035), (2-ethylhexyl)-2-cyano-3,3-diphenylacrylate (UVINUL™ 3039), N,N′-bisformyl-N,N′-bis(2,2,6,6-tetramethyl-4-piperidinyl)hexamethylendia-mine (UVINUL™ 4050H), bis-(2,2,6,6-tetramethyl-4-piperidyl)-sebacate (UVINUL™ 4077H), bis-(1,2,2,6,6-pentamethyl-4-piperdiyl)-sebacate+methyl-(1,2,2,6,6-pentam-ethyl-4-piperidyl)-sebacate (UVINUL™ 4092H) 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; TINUVIN™ 234; nano-size inorganic materials such as titanium oxide, cerium oxide, and zinc oxide, all with particle size less than or equal to 100 nanometers; or the like, or combinations comprising at least one of the foregoing UV absorbers.

In certain aspects the ultraviolet stabilizer may be present in the thermoplastic composition in an amount of from about 0.1 wt % to about 3 wt %. In other aspects the intrinsically conductive polymer may be present in the thermoplastic composition in an amount of from about 0.2 wt % to about 2 wt %, or from about 0.1 wt % to about 0.5 wt %.

### Colorant/Dye

The colorant or dye may include pigment and/or dye additives. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments.

Exemplary dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes.

In certain aspects the colorant or dye may be present in the thermoplastic composition in an amount of from about 0.1 wt % to about 10 wt %.

### Optional Additives

In addition to the foregoing components, the disclosed thermoplastic compositions can optionally include an effective amount of one or more additive materials ordinarily incorporated in thermoplastic compositions of this type, with the proviso that the additives are selected so as to not significantly adversely affect the desired properties of the composition. Combinations of additives can be used. Such additives can be mixed at a suitable time during the mixing of the components for forming the composition. Exemplary and non-limiting examples of additive materials that can be present in the disclosed thermoplastic compositions include one or more of a radio frequency transparent filler, compatibilizer, enhancer, acid scavenger, anti-drip agent, antioxidant, antistatic agent, chain extender, processing aid (e.g., mold release component, flow modifier component, and/or process stabilizer), plasticizer, quenching agent, additional flame retardant (including for example a thermal stabilizer, a hydrolytic stabilizer, or a light stabilizer), impact modifier, UV absorbing additive, and UV reflecting additive.

In an aspect, suitable impact modifiers can include an epoxy-functional block copolymer. The epoxy-functional block copolymer can include units derived from a C₂₋₂₀ olefin and units derived from a glycidyl (meth)acrylate. Exemplary olefins include ethylene, propylene, butylene, and the like. The olefin units can be present in the copolymer in the form of blocks, e.g., as polyethylene, polypropylene, polybutylene, and the like blocks. It is also possible to use mixtures of olefins, i.e., blocks containing a mixture of ethylene and propylene units, or blocks of polyethylene together with blocks of polypropylene.

In one aspect, the impact modifier is terpolymeric, comprising polyethylene blocks, methyl acrylate blocks, and glycidyl methacrylate blocks. Specific impact modifiers are a co- or terpolymer including units of ethylene, glycidyl methacrylate (GMA), and methyl acrylate. Suitable impact modifiers include the ethylene-methyl acrylate-glycidyl methacrylate terpolymer comprising 8 wt % glycidyl methacrylate units available under the trade name LOTADER™ AX8900. Another epoxy-functional block copolymer that can be used in the composition includes ethylene acrylate, for example an ethylene-ethylacrylate copolymer having an ethylacrylate content of less than 20%, available from Rohm and Haas (Dow Chemical) under the trade name Paraloid™ EXL-3330. It will be recognized that combinations of impact modifiers may be used.

In a further aspect, the disclosed thermoplastic compositions can further include an antioxidant or “stabilizer.” Numerous stabilizers are known may be used, in one aspect the stabilizer is a hindered phenol, such as IRGANOX™ 1010, available from BASF. Other suitable stabilizers include but are not limited to phosphoric acid, phosphorous acid, acidic phosphate salt or octadecyl phosphate (e.g., octadecyl dihydrogen phosphate and dioctadecyl hydrogen phosphate), which may reduce degradation of the thermoplastic polymer (e.g., polycarbonate). These stabilizers—and in particular phosphoric acid, phosphorous acid, acidic phosphate salt or octadecyl phosphate (e.g., octadecyl dihydrogen phosphate and dioctadecyl hydrogen phosphate)—may also deactivate or “quench” residual catalyst that remains in the intrinsically conductive polymer when it is formed.

The electrostatic dissipative composition may include a compatibilizer. A compatibilizer, or compatibilizing agent, or other derivatives, may refer to polyfunctional compounds which can interact with the components of the disclosed thermoplastic composition. The compatibilizer may be added to improve the miscibility between the thermoplastic polymer, intrinsically conductive polymer, and other components. The interaction may be chemical (e.g., grafting) and/or physical (e.g., affecting the surface characteristics of the dispersed resin phases). Exemplary compatibilizers may include liquid diene polymers, epoxy compounds, oxidized polyolefin wax, quinones, organosilane compounds, polyfunctional compounds, functionalized polyolefins (such as maleic anhydride functionalized polyolefins), and combinations comprising at least one of the foregoing. Compatibilizers are further described in U.S. Pat. Nos. 5,132,365 and 6,593,411 as well as U.S. Patent Application No. 2003/0166762.

The thermoplastic composition includes a reinforcing filler that is a radio frequency (RF) transparent reinforcing filler. A radio frequency transparent reinforcing filler refers to a filler that allows the passage of radio frequencies (880 MHz to 2.5 GHz) there through. For example, the radio frequency transparent reinforcing filler may be transparent greater than 80%, greater than 85%, greater than 90%, greater than 95%, greater than 99%. Thus the RF transparent filler may be transparent to electromagnetic radiation in the radio-frequency (RF) spectral range. Radio frequency may be measured according to a number of known methods, including for example, using an RF meter. Exemplary but by no means limited reinforcing fillers suitable for aspects of the disclosure include glass fiber (e.g., E glass, flat glass, and S glass) and ceramic fiber.

In some aspects the thermoplastic composition includes a processing aid, including but not limited to a mold release component. Suitable mold release components include, but are not limited to, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. In particular aspects the composition includes a mold release component in the amount of from about 0.2 wt % to about 2 wt %.

Compositions of the present disclosure may comprise a catalyst deactivator. The intrinsically conductive/dissipative polymer may have basic catalyst residues that may degrade polycarbonate. It is noted that basic catalyst residues used in the formation of a given intrinsically conductive/dissipative polymer may remain in the intrinsically conductive/dissipative polymer and may degrade potentially degrade polycarbonate in the composition. That is, in the presence of the catalyst, the polycarbonate may degrade as evidenced by a higher flow rate. The catalyst deactivator, normally an acid or acid salt, may deactivate or quench the catalyst to prevent degradation of polycarbonate where polycarbonate is used at as the polymer. The catalyst deactivator may comprise phosphoric acid, phosphorous acid, acidic phosphate salt or octadecyl phosphate.

### Properties of Thermoplastic Compositions

Thermoplastic compositions according to aspects of the disclosure may have various properties suitable for use in personal protective equipment, including but not limited to flame resistance, ultraviolet stability, temperature resistance, impact properties, chemical resistance, and/or electrostatic dissipative capability

In various aspects, the disclosed composition has electrostatic dissipative properties. The composition may have a surface resistivity of from about 10⁶ to about 10⁹ ohms/square (Ω/sq) when tested in accordance with ASTM D257. In certain aspects the composition is transparent to radio frequency signals.

Flame resistance of the thermoplastic composition according to aspects of the disclosure may be quantified by the composition having a V0 rating at a thickness of about 0.8 mm to about 2.5 mm when tested in accordance with UL 94.

The thermoplastic compositions may also have desirable impact strength properties. In particular aspects the composition does not break under unnotched Izod impact strength at room temperature under test conditions of ASTM D256 with a pendulum energy of 11 J. In yet further aspects the composition has a notched Izod impact strength of at least about 200 Joules/meter (J/m) when tested in accordance with ASTM D256. In further examples, the composition may not break under unnotched Izod impact test conditions at 23° C. The composition may exhibit an unnotched Izod impact strength of at least 800 J/m at −25° C. The composition may exhibit a notched Izod impact strength of at least 200 J/m at 23° C. and at least 75 J/m at −25° C.

The composition may exhibit chemical resistance to acid and oil. The composition is also colorable and/or dyeable in certain aspects. Colorable or dyeable may refer to the characteristic or ability of the composition to be colored or dyed using a colorant or pigment. The colorant or pigment may be a component of the disclosed thermoplastic composition.

As further discussed below, in particular aspects the composition is processable at a temperature of between about 232.2° C. (450° F.) and about 304.4° C. (580° F.).

In certain aspects a specimen of the composition does not delaminate when bent until the specimen breaks. Delamination may be determined according to a procedure in which a UL (e.g., UL 94) 1.5 millimeter (mm) bar is formed from the thermoplastic composition. The bar is bent until it breaks, and then a cross section of the broken bar is analyzed for delamination and evaluated on a subjective scale of 1 (no delamination) to 5 (fully delaminated, like an onion). The delamination test could cause homogeneous blends of composition/articles to be delaminated. Factors that may affect delamination include, but are not limited to, polymer domain size and polymer morphology. Domain size and morphology may be controlled by the formulation of the composition and the method of compounding.

### Methods for Making Thermoplastic Compositions

The one or any foregoing components described herein may first be dry blended together, then fed into an extruder from one or multi-feeders, or separately fed into an extruder from one or multi-feeders. The one or any foregoing components may be first dry blended with each other, or dry blended with any combination of foregoing components, then fed into an extruder from one or multi-feeders, or separately fed into an extruder from one or multi-feeders. The components may be fed into the extruder from a throat hopper or any side feeders.

The extruders used in the disclosure may have a single screw, multiple screws, intermeshing co-rotating or counter rotating screws, non-intermeshing co-rotating or counter rotating screws, reciprocating screws, conical screws, screws with pins, screws with screens, barrels with pins, rolls, rams, helical rotors, co-kneaders, disc-pack processors, various other types of extrusion equipment, or combinations comprising at least one of the foregoing.

The components may also be mixed together and then melt-blended to form the thermoplastic compositions. The melt blending of the components involves the use of shear force, extensional force, compressive force, ultrasonic energy, electromagnetic energy, thermal energy or combinations comprising at least one of the foregoing forces or forms of energy. The barrel temperature on the extruder during compounding can be set at the temperature where at least a portion of the thermoplastic polymer has reached a temperature greater than or equal to about the melting temperature, if the polymer is a semi-crystalline organic polymer, or the flow point (e.g., the glass transition temperature) if the polymer is an amorphous polymer.

The mixture including the foregoing components may be subject to multiple blending and forming steps if desirable. For example, the moldable composition may first be extruded and formed into pellets. The pellets may then be fed into a molding machine where it may be formed into any desirable shape or product. Alternatively, the moldable composition emanating from a single melt blender may be formed into sheets or strands and subjected to post-extrusion processes such as annealing, uniaxial or biaxial orientation.

The temperature of the melt in the present process may in some aspects be maintained as low as possible in order to avoid excessive degradation of the components (e.g., the thermoplastic polymer). In certain aspects the melt temperature is maintained between about 232.2° C. (450° F.) and about 304.4° C. (580° F.). In some aspects the melt processed composition exits processing equipment such as an extruder through small exit holes in a die. The resulting strands of molten resin may be cooled by passing the strands through a water bath. The cooled strands can be chopped into small pellets for packaging and further handling.

The thermoplastic compositions may be formed by a method other than extrusion. Such methods include, but are not limited to injection molding, compression molding and additive manufacturing.

In particular aspects a method for making a thermoplastic composition includes: combining a polycarbonate polymer component, an antidripping agent, an ultraviolet (UV) stabilizer, and optionally a colorant or dye to form a mixture; adding the mixture at a feed throat of an extruder and compounding the mixture in the extruder; adding an intrinsically conductive polymer to the mixture at either the feed throat of the extruder or downstream in the extruder; adding a liquid flame retardant to the mixture into the extruder through a liquid feed port; and extruding the mixture to form the thermoplastic composition.

In the aspect of this method the feeding location of the flame retardant may be selected so as to improve the quality of the mixing of the flame retardant additive and the polymer melt, and also to improve the efficiency of the melting of the polymers in the composition. For example, as discussed above, in a particular aspect in which the thermoplastic composition is formed from an extrusion process, a liquid flame retardant may be added into the extruder containing the other components downstream in the extruder through a liquid feed port in the extruder.

The feeding location of the intrinsically conductive/dissipative polymer may be selected so as to minimize degradation thereof. Some intrinsically conductive/dissipative polymers may degrade if added at the feed throat of the extruder and thus it may be desirable to add them downstream in the extruder to minimize their degradation.

The disclosed composition may be compounded using a Werner-Pfliederer ZSK Super 10 barrel (41.25 length/diameter, L/D) 40 mm twin screw extruder. The thermoplastic polymer or blends thereof may be added at the feed throat of the extruder along with the additional components. The intrinsically conductive/dissipative polymer may be added either at the feed throat, downstream in a side feeder, or split fed at the feed throat or downstream through the side feeder. A liquid flame retardant may be added downstream through the liquid injection feeder or downstream of the extruder. The screw configuration of the extruder may have one melting zone and one or two mixing zones to accommodate the one or two feeders downstream. In particular aspects the extruder may have the following range of processing parameters: a barrel temperature of about 250° F. to about 550° F.; a screw speed of about 100 to about 1200 revolutions per minute (RPM); and a feed rate of about 100 to about 600 pounds per hour (lb/hr).

### Articles of Manufacture

In certain aspects, the present disclosure pertains to shaped, formed, or molded articles comprising the thermoplastic compositions. The thermoplastic compositions can be molded into useful shaped articles by a variety of means such as injection molding, extrusion, rotational molding, blow molding, additive manufacturing and thermoforming to form articles and structural components of, for example, personal protective equipment such as a protective helmet. Various combinations of elements of this disclosure are encompassed by this disclosure, e.g., combinations of elements from dependent claims that depend upon the same independent claim. The disclosed compositions may be useful as components of personal protective equipment (PPE) such as safety helmets may include the capability to communicate real-time using audio and video transmission and safety features to work in the hazardous environments. The disclosed thermoplastic compositions may be transparent to RF transmission and/or will allow the compositions to meet the ATEX Directive (94/9/EC) and/or EN 50014 in a potentially explosive atmosphere. The disclosed composition may further be useful in PPE equipment or materials as the compositions provide additional properties, such as ultraviolet (UV) stability, temperature resistance, impact properties, chemical resistance, flammability and electrostatic dissipative capability. As the disclosed composition may be colorable or dyeable, these compositions may comply with portions of the Occupational Safety and Health Act (OSHA) that may require that an industry color-code its safety protective equipment.

The disclosed electrostatic dissipative compositions may thus exhibit multifunctional capability and may improve upon conventional thermoplastic compositions for which many of the characteristic requirements negatively affect each other as described herein. Electrostatic dissipative compositions of the present disclosure achieve a balance among the various properties.

### Aspects of the Disclosure

In various aspects, the present disclosure pertains to and includes at least the following aspects.

Aspect 1. An electrostatic dissipative thermoplastic composition comprising: a. a polycarbonate polymer component comprising a polycarbonate resin, a polysiloxane-polycarbonate copolymer, and a brominated polycarbonate resin; b. an intrinsically conductive or dissipative polymer or a blend thereof, wherein the intrinsically conductive or dissipative polymer has a surface resistivity less than or equal to 107 ohm/sq; c. a flame retardant; d. an antidripping agent; and e. an ultraviolet (UV) stabilizer.

Aspect 2. The electrostatic dissipative thermoplastic composition of claim 1, further comprising a catalyst deactivator.

Aspect 3. The electrostatic dissipative thermoplastic composition according to any one of aspects 1-2, further comprising a catalyst deactivator, wherein the catalyst deactivator comprises phosphoric acid, phosphorous acid, acidic phosphate salt or octadecyl phosphate.

Aspect 4. An electrostatic dissipative thermoplastic composition comprising: a. a polycarbonate polymer component comprising a polycarbonate resin, a polysiloxane-polycarbonate copolymer, and a brominated polycarbonate resin; b. an intrinsically conductive or dissipative polymer or a blend thereof, wherein the intrinsically conductive or dissipative polymer has a surface resistivity less than or equal to 10⁷ ohm/sq; c. a flame retardant; d. an antidripping agent; e. an ultraviolet (UV) stabilizer; and f. a catalyst deactivator.

Aspect 5. The electrostatic dissipative thermoplastic composition according to any one of aspects 1-3, wherein the polysiloxane-polycarbonate copolymer is present in an amount between 1-80 wt % of the polycarbonate polymer component.

Aspect 6. The electrostatic dissipative thermoplastic composition according to any of claims 1 to 5, wherein the brominated polycarbonate resin is present in an amount equal to or less than 50% of the total polycarbonate polymer component.

Aspect 7. The thermoplastic composition according to any one of aspects 1-6, wherein the brominated polycarbonate resin is present in an amount between 10-50 wt %. of the total polycarbonate polymer component.

Aspect 8. The thermoplastic composition according to any one of aspects 1-6, wherein the brominated polycarbonate resin is present in an amount between 10-40 wt %. of the total polycarbonate polymer component.

Aspect 9. The thermoplastic composition according to any one of aspects 1-6, wherein the brominated polycarbonate resin is present in an amount between 20-50 wt %. of the total polycarbonate polymer component.

Aspect 8. The thermoplastic composition according to any of claims 1 to 6, further comprising an impact modifier.

Aspect 9. The thermoplastic composition according to any of claims 1 to 7, further comprising a radio frequency transparent reinforcing filler.

Aspect 10. The thermoplastic composition according to aspect 8, wherein the radio frequency transparent filler comprises a glass or ceramic fiber.

Aspect 11. The thermoplastic composition according to any of claims 8-9, wherein the radio frequency transparent filler is present in an amount of from 1 to 30 wt. % based on the total weight of the electrostatic dissipative thermoplastic composition.

Aspect 12. The thermoplastic composition according to any of claims 1 to 11, further comprising a processing aid, the processing aid comprising at least one of a mold release component, a flow modifier component and a process stabilizer.

Aspect 13. The electrostatic dissipative thermoplastic composition according to any of claims 1 to 12, wherein flame retardant additive comprises phosphorous.

Aspect 14. The electrostatic dissipative thermoplastic composition according to any of claims 1 to 13, wherein the antidripping agent comprises styrene acrylonitrile (SAN) encapsulated polytetrafluoroethylene (PTFE).

Aspect 15. The electrostatic dissipative thermoplastic composition according to any of claims 1 to 14, wherein the intrinsically conductive polymer comprises a block copolymer, wherein the block copolymer comprises a polyamide-poly(ethylene oxide) (PEO) block copolymer (polyetheresteramide).

Aspect 16. The electrostatic dissipative thermoplastic composition according to any of claims 1 to 15, further comprising a colorant or a dye.

Aspect 17. The electrostatic dissipative thermoplastic composition according to any of claims 1 to 16, wherein the flame retardant comprises phosphazene, aryl phosphate, bisphenol A diphosphate, resorcinol bis-diphenylphosphate, bisphenol A diphenyl phosphate, resorcinol diphosphate, or a combination thereof.

Aspect 18. The thermoplastic composition according to any of claims 1-17, further comprising a compatibilizer.

Aspect 19. The thermoplastic composition according to aspect 18, wherein the compatibilizer comprises a maleic anhydride (MAH) grafted polymer.

Aspect 20. The thermoplastic composition according to any one of claims 1-19, further comprising an impact modifier.

Aspect 21: The thermoplastic composition according to any of Aspects 1 to 20, wherein the composition has electrostatic dissipation properties.

Aspect 22: The thermoplastic composition according to any of Aspects 1 to 20, wherein the composition has a surface resistivity of from about 10⁶ to about 10⁹ ohms/square (Ω/sq) when tested in accordance with ASTM D257.

Aspect 23: The thermoplastic composition according to any of Aspects 1 to 20, wherein the composition is transparent to radio frequency signals.

Aspect 24: The thermoplastic composition according to any of Aspects 1 to 20, wherein the composition has a V0 rating at a thickness of about 0.8 mm to about 2.5 mm when tested in accordance with UL 94.

Aspect 25: The thermoplastic composition according to any of Aspects 1 to 20, wherein the composition does not break under unnotched Izod impact test conditions of ASTM D256 with a pendulum energy of 11 J.

Aspect 26: The thermoplastic composition according to any of Aspects 1 to 20, wherein the composition has a notched Izod impact strength of at least about 200 J/m when tested in accordance with ASTM D256.

Aspect 27: The thermoplastic composition according to any of Aspects 1 to 20, wherein the composition has chemical resistance to acid and oil.

Aspect 28: The thermoplastic composition according to any of Aspects 1 to 20, wherein the composition is processable at temperature of between about 232.2° C. (450° F.) and about 304.4° C. (550° F.).

Aspect 29: The thermoplastic composition according to any of Aspects 1 to 20, wherein the composition comprises a mold release component in the amount of from about 0.2 wt % to about 2 wt %.

Aspect 30: The thermoplastic composition according to any of Aspects 1 to 20, wherein a specimen of the composition does not delaminate when bent until the specimen breaks.

Aspect 31. The electrostatic dissipative thermoplastic composition according to any of claims 4 to 30, wherein the catalyst deactivator comprises phosphoric acid, phosphorous acid, acidic phosphate salt or octadecyl phosphate.

Aspect 32: A molded article formed from the thermoplastic composition of any of Aspects 1 to 31.

Aspect 33. The thermoplastic composition according to any of claims 1 to 20, wherein the thermoplastic composition has one or more of the following properties: electrostatic dissipation properties according to ATEX Directive (94/9/EC) and/or EN 50014 in a potentially explosive atmosphere; a surface resistivity of from about 106 to about 109 ohms/square (Ω/sq) when tested in accordance with ASTM D257; the thermoplastic composition is transparent to radio frequency signals; the composition does not break under unnotched Izod impact test conditions at room temperature, when tested in accordance with ASTM D256 with a pendulum energy of 11 J; the thermoplastic composition has a V0 rating at a thickness of about 0.8 mm to about 2.5 mm when tested in accordance with UL 94; the thermoplastic composition does not break under unnotched Izod impact test conditions of ASTM D256 with a pendulum energy of 11 J; the composition has an unnotched Izod impact strength of at least 800 J/m at −25° C., when tested in accordance with ASTM D256 with a pendulum energy of 11 J; the thermoplastic composition has a notched Izod impact strength of at least about 75 J/m at −25° C. when tested in accordance with ASTM D256; and the composition is colorable or dyeable.

Aspect 34. The thermoplastic composition according to any of claims 1 to 20, wherein the thermoplastic composition has one or more of the following properties: electrostatic dissipation properties according to ATEX Directive (94/9/EC) and/or EN 50014 in a potentially explosive atmosphere; a surface resistivity of from about 106 to about 109 ohms/square (Ω/sq) when tested in accordance with ASTM D257; the thermoplastic composition is transparent to radio frequency signals; the thermoplastic composition has a V0 rating at a thickness of about 0.8 mm to about 2.5 mm when tested in accordance with UL 94; the thermoplastic composition does not break under unnotched Izod impact test conditions of ASTM D256 with a pendulum energy of 11 J; the composition has an unnotched Izod impact strength of at least 800 J/m at −25° C. when tested in accordance with ASTM D256 with a pendulum energy of 11 J; the thermoplastic composition has a notched Izod impact strength of at least about 75 J/m at −25° C. when tested in accordance with ASTM D256; and the composition is colorable or dyeable.

Aspect 35. The thermoplastic composition according to any of claims 1 to 32, wherein the thermoplastic composition comprises: a. from about 40 wt % to about 85 wt % polycarbonate component containing 1 −80 wt % of polysiloxane-polycarbonate copolymer and 10-50 wt % brominated polycarbonate in the polycarbonate polymer component based on the weight of the polycarbonate polymer component composition; b. from about 5 wt % to about 50 wt % intrinsically conductive/dissipative polymer; c. from about 3 wt % to about 25 wt % flame retardant; d. from about 0.1 wt % to about 5 wt % antidripping agent; e. from about 0.1 wt % to about 3 wt % UV stabilizer; and f. from about 0.1 wt % to about 10 wt % colorant or dye, based on the total weight of the thermoplastic composition.

Aspect 36. The thermoplastic composition according to any of claims 1 to 20, wherein the electrostatic dissipative thermoplastic composition comprises a mold release component in an amount of from about 0.2 wt % to about 2 wt %.

Aspect 37. A molded article formed from the thermoplastic composition of any of claims 1 to 36.

Aspect 38: A method for making a thermoplastic composition, comprising: combining a polycarbonate polymer component, an antidripping agent, an ultraviolet (UV) stabilizer, and optionally a colorant or dye to form a mixture; adding the mixture at a feed throat of an extruder and compounding the mixture in the extruder; adding an intrinsically conductive polymer to the mixture at either the feed throat of the extruder or downstream in the extruder;

adding a liquid flame retardant to the mixture downstream in the extruder through a liquid feed port in the extruder; and extruding the mixture to form the thermoplastic composition.

Aspect 39. The method of Aspect 38, further comprising a compatibilizer.

Aspect 40. The method according to Aspect 38 or 39, further comprising a catalyst deactivator, wherein the catalyst deactivator comprises phosphoric acid, phosphorous acid, acidic phosphate salt or octadecyl phosphate.

Aspect 41. The method according to any of Aspects 38-40, further comprising an impact modifier.

Aspect 42. The method according to any of Aspects 38-41, further comprising a radio frequency transparent reinforcing fiber.

Aspect 43. The method according to any of Aspects 38-41, further comprising a glass fiber or a ceramic fiber.

Aspect 44. The method according to any of Aspects 38-43, further comprising a processing aid, the processing aid comprising at least one of a mold release component, a flow modifier component and a process stabilizer.

Aspect 45. The method according to any of Aspects 38-44, wherein the polycarbonate polymer component comprises a polycarbonate resin, a polysiloxane-polycarbonate copolymer, and a brominated polycarbonate resin

Aspect 46. The method according to any of Aspects 38-45, wherein the intrinsically conductive/dissipative polymer comprises a block copolymer.

Aspect 47. The method according to Aspect 46, wherein the block copolymer comprises a polyesterimide.

Aspect 48. The method according to Aspect 46, wherein the block copolymer comprises a polyamide-poly(ethylene oxide) (PEO) block copolymer (polyetheresteramide).

Aspect 49. The method according to any of Aspects 38-48, wherein the flame retardant comprises phosphazene, aryl phosphate, bisphenol A diphosphate, resorcinol bis-diphenylphosphate, bisphenol A diphenyl phosphate, resorcinol diphosphate, or a combination thereof.

Aspect 50. The method according to any of Aspects 38-49, wherein the thermoplastic composition has electrostatic dissipation properties.

Aspect 51. The method according to any of Aspects 38-49, wherein the thermoplastic composition has a surface resistivity of from about 10⁶ to about 10⁹ ohms/square (Ω/sq) when tested in accordance with ASTM D257.

Aspect 52. The method according to any of Aspects 38-49, wherein the thermoplastic composition is transparent to radio frequency signals.

Aspect 53. The method according to any of Aspects 38-49, wherein the thermoplastic composition has a V0 rating at a thickness of about 0.8 mm to about 2.5 mm when tested in accordance with UL 94.

Aspect 54. The method according to any of Aspects 38-49, wherein the thermoplastic composition does not break under unnotched Izod impact test conditions of ASTM D256 with a pendulum energy of 11 J.

Aspect 55. The method according to any of Aspects 38-49, wherein the thermoplastic composition has a notched Izod impact strength of at least about 75 J/m when tested in accordance with ASTM D256.

Aspect 56. The method according to any of Aspects 38-49, wherein the thermoplastic composition has chemical resistance to acid and oil.

Aspect 57. The method according to any of Aspects 38-49, wherein the thermoplastic composition is processable at temperature of between about 232.3° C. (450° F.) and about 304.4° C. (550° F.).

Aspect 58. The method according to any of Aspects 38-49, wherein the thermoplastic composition is colorable or dyeable.

Aspect 59. The method according to any of Aspects 38-58, wherein the thermoplastic composition comprises: from about 40 wt % to about 90 wt % of the polycarbonate polymer component; from about 5 wt % to about 50 wt % intrinsically conductive/dissipative polymer; from about 3 wt % to about 25 wt % flame retardant; from about 0.1 wt % to about 5 wt % antidripping agent; from about 0.1 wt % to about 3 wt % UV stabilizer; and from about 0.1 wt % to about 10 wt % colorant or dye.

Aspect 60. The method according to any of Aspects 38-60, wherein the thermoplastic composition comprises a mold release component in the amount of from about 0.2 wt % to about 2 wt %.

Aspect 61. The method according to any of Aspects 38-61, wherein a specimen of the thermoplastic composition does not delaminate when bent until the specimen breaks.

Aspect 62. The thermoplastic composition according to any of Aspects 38-62, wherein a metal salt/ion is coordinately bonded to the intrinsically conductive polymer.

Aspect 63. The thermoplastic composition according to any of Aspects 38-62, wherein a non-metal salt/ion is coordinately bonded to the intrinsically conductive polymer.

Aspect 64. The method according to any of Aspects 32 to 62, wherein a metal salt/ion is coordinately bonded to the intrinsically conductive/dissipative polymer.

Aspect 65. The method according to any of Aspects 32 to 62, wherein a non-metal salt/ion is coordinately bonded to the intrinsically conductive polymer.

Aspect 66. An electrostatic dissipative thermoplastic composition comprising: a. a polycarbonate polymer comprising a polycarbonate resin, a polysiloxane-polycarbonate copolymer, and a brominated polycarbonate resin; b. an intrinsically conductive or dissipative polymer or a blend thereof, wherein the intrinsically conductive or dissipative polymer has a surface resistivity less than or equal to 107 ohm/sq; c. a flame retardant; d. an antidripping agent; and e. an ultraviolet (UV) stabilizer, wherein the electrostatic dissipative thermoplastic composition is colorable or dyeable.

Aspect 67. An electrostatic dissipative thermoplastic composition comprising: a. a polycarbonate polymer component comprising a polycarbonate resin, a polysiloxane-polycarbonate copolymer, and a brominated polycarbonate resin; b. an intrinsically conductive or dissipative polymer or a blend thereof, wherein the intrinsically conductive or dissipative polymer has a surface resistivity less than or equal to 10⁷ ohm/sq; c. a flame retardant; d. an antidripping agent; e. an ultraviolet (UV) stabilizer; and f. a catalyst deactivator, wherein the electrostatic dissipative thermoplastic is colorable or dyeable.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

### Examples

The following examples are presented to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Formulations were prepared using a Werner-Pfliederer ZSK Super 10 barrel (41.25 L/D) 40 mm twin screw extruder. The thermoplastic polymer was added at the feed throat of the extruder along with the stabilizers, processing aid and mold release. The conductive/dissipative polymer was added either at the feed throat or at downstream with side feeder or split fed at the feed throat and downstream through the side feeder. A liquid flame retardant was added at downstream through the liquid injection feeder. The screw configuration has one melting zone and one or two mixing zones to accommodate the one or two feeders at downstream. The ranges for processing parameters were: Barrel temperature: 232.2 to 304.4° C. (450 to 580° F.); screw speed: 100 to 1200 RPM; and feed rate: 100 to 600 lb/hr. Table 1 presents the samples and formulation amounts for examples 1-5 (Ex1-Ex5).

TABLE 1
Formulations

| | | Compositions | | | | |
|---|---|---|---|---|---|---|
| Component | Description | Ex1 | Ex2 | Ex3 | Ex 4 | Ex 5 |
| SABIC Lexan ™ | Polycarbonate blend containing | 70.2 | 70.1 | 67.1 | 64.1 | 28.1 |
| EXL9330-WH3064 | polycarbonate-siloxane copolymer; | | | | | |
| | about 22% PC siloxane copolymer | | | | | |
| SABIC Lexan ™ | Brominated Polycarbonate | | | | | 42 |
| ML4365-111N | | | | | | |
| Pelectron ™ AS Sanyo | Polyesterimide; intrinsically | 20 | 20 | 20 | 20 | 20 |
| Chemical | dissipative polymer | | | | | |
| Fyrolflex ™ RDP | Flame retardant | 8 | 8 | 11 | 14 | 8 |
| SABIC ™ | Polytetrafluoroethylene-styrene- | 1 | 1 | 1 | 1 | 1 |
| TSAN/BLENDEX | acrylonitrile; Drip suppressing agent | | | | | |
| Z708 (Teflon ™) | | | | | | |
| Phosphoric acid | Catalyst deactivator | | 0.1 | 0.1 | 0.1 | 0.1 |
| Lonza Glycolube ™ | Mold release; pentaerythritol | 0.5 | 0.5 | 0.5 | 0.5 | 0.5 |
| PETS | tetrastearate | | | | | |
| Irganox ™ 1076 | Process stabilizer; octadecyl-3-(3,5- | 0.15 | 0.15 | 0.15 | 0.15 | 0.15 |
| | di-tert.butyl-4-hydroxyphenyl)- | | | | | |
| | propionate | | | | | |
| Irgafos ™ 168 | Process stabilizer; Tris(2,4-ditert- | 0.15 | 0.15 | 0.15 | 0.15 | 0.15 |
| | butylphenyl)phosphite | | | | | |

Performance results for the Ex1-Ex5 are presented in Table 2.

| Properties | Standard | unit | Ex1 | Ex2 | Ex3 | Ex 4 | Ex 5 |
|---|---|---|---|---|---|---|---|
| Flexural modulus | ASTM | MPa | 1760 | 1750 | 1800 | 1820 | 1860 |
| | D790 | | | | | | |
| Flexural strength | ASTM | MPa | 61 | 63 | 60 | 58 | 68 |
| | D790 | | | | | | |
| Notched Izod Impact | ASTM | J/m | 98 | 977 | 949 | 742 | 40 |
| Strength, 23 C. | D256 | | | | | | |
| Notched Izod Impact | ASTM | J/m | 54 | 227 | 165 | 158 | 32 |
| Strength, −25° C. | D256 | | | | | | |
| Unnotched Izod Impact | ASTM | J/m | NB | NB | NB | NB | NB |
| Strength, 23° C. | D256 | | | | | | |
| Unnotched Izod Impact | ASTM | J/m | 920 | 1450 | 1260 | 1100 | 675 |
| Strength, −25° C. | D256 | | | | | | |
| Surface resistivity | ASTM | ohm/sq | 5.0E+08 | 6.0E+08 | 6.0E+08 | 5.0E+08 | 5.0E+08 |
| | D257 | | | | | | |
| UL 94 flammability | UL94 | UL 94 | NR | NR | NR | NR | V0 |
| at 2 mm | | flammability | | | | | |
| | | at 1.8 mm | | | | | |
| Melt volume rate (MVR), | ASTM | cm³/10 | 83 | 46 | 48 | 58 | 48 |
| 240 C., 5 kg | D1238 | min | | | | | |

| | | | | | |
|---|---|---|---|---|---|
| Meets flammability? | No | No | No | No | Yes |
| Meets impact? | No | Yes | Yes | Yes | No |

Example 1 (Ex1), which did not contain a brominated polycarbonate and a catalyst deactivator, did not pass the required impact and flammability, but the surface resistivity was in the desired ESD range 10⁶-10⁹ ohm/sq. A higher flow (MVR) indicates the degradation of polycarbonate. When the catalyst deactivator was added (Ex2), flow reduced significantly indicating successful prevention of polycarbonate degradation. This also improved both the notched and unnotched Izod impact strength significantly. However, Ex2 still did not meet the UL 94 V0 rating. NR indicates “no rating”. To improve the flammability rating, the flame retardant loading was increased in examples 3 and 4, but the samples still did not pass the flammability test. When brominated polycarbonate was added to the composition (60 wt % of the total resin composition), the sample met the requirements for UL94 V0 flammability (Ex5). However, the notched Izod impact strength dropped significantly. To evaluate whether we can achieve both the required flammability rating and Izod impact strength by manipulating the brominated polycarbonate loading, a second set of formulations example 6 through 9 (Ex6-Ex9) were designed. Table 3 presents the formulations for Ex6-Ex9.

Table 3 presents formulations for Ex6-9.

| | | Compositions | | | |
|---|---|---|---|---|---|
| Components | Description | Ex6 | Ex7 | Ex8 | Ex 9 |
| SABIC Lexan ™ | Polycarbonate | 65.1 | 56.1 | 46.1 | 35.1 |
| EXL9330-WH3064 | blend containing | | | | |
| | polycarbonate- | | | | |
| | siloxane copolymer | | | | |
| SABIC Lexan ™ | Brominated | 5 | 14 | 24 | 35 |
| ML4365-111N | Polycarbonate | | | | |
| Pelectron ™ AS | Intrinsically | 20 | 20 | 20 | 20 |
| Sanyo Chemical | dissipative polymer | | | | |
| Fyrolflex ™ RDP | Flame retardant | 8 | 8 | 8 | 8 |
| SABIC TSAN/ | Drip suppressing | 1 | 1 | 1 | 1 |
| BLENDEX Z708 | agent | | | | |
| Phosphoric acid | Catalyst deactivator | 0.1 | 0.1 | 0.1 | 0.1 |
| Lonza Glycolube ™ | Mold release | 0.5 | 0.5 | 0.5 | 0.5 |
| PETS | | | | | |
| Irganox ™ 1076 | Process stabilizer | 0.15 | 0.15 | 0.15 | 0.15 |
| Irgafos ™ 168 | Process stabilizer | 0.15 | 0.15 | 0.15 | 0.15 |

Results for samples evaluated above are presented in Table 4.

TABLE 4
Performance results for samples Ex6 through Ex9.

| Properties | Standard | unit | Ex6 | Ex7 | Ex8 | Ex 9 |
|---|---|---|---|---|---|---|
| Flexural modulus | ASTM | MPa | 1810 | 1810 | 1820 | 1840 |
| | D790 | | | | | |
| Flexural strength | ASTM | MPa | 64 | 66 | 65 | 68 |
| | D790 | | | | | |
| Notched Izod Impact | ASTM | J/m | 980 | 997 | 986 | 967 |
| Strength, 23 C. | D256 | | | | | |
| Notched Izod Impact | ASTM | J/m | 185 | 170 | 150 | 135 |
| Strength, −25° C. | D256 | | | | | |
| Unnotched Izod Impact | ASTM | J/m | NB | NB | NB | NB |
| Strength, 23° C. | D256 | | | | | |
| Unnotched Izod Impact | ASTM | J/m | 1350 | 1260 | 1200 | 1140 |
| Strength, −25° C. | D256 | | | | | |
| Surface resistivity | ASTM | ohm/sq | 6.00E+08 | 5.00E+08 | 5.00E+08 | 5.00E+08 |
| | D257 | | | | | |
| UL 94 flammability | UL94 | UL 94 | NR | V0 | V0 | V0 |
| at 2 mm | | flammability | | | | |
| | | at 1.8 mm | | | | |
| Melt volume rate (MVR), | ASTM | cm³/10 | 50 | 53 | 55 | 49 |
| 240 C., 5 kg | D1238 | min | | | | |

| | | | | |
|---|---|---|---|---|
| Meets flammability? | no | Yes | Yes | Yes |
| Meets impact? | Yes | Yes | Yes | Yes |

Results from Ex6 indicates that at a lower loading of brominated PC (5 wt % of the total composition, 7 wt % of the polycarbonate resin composition), the sample still fails the UL94 V0 flammability test. In Example 6, the total polycarbonate is 70.1 wt. % (65.1+5), so brominated PC is 7% of the total PC composition and 5 wt % of the total composition. At higher loadings of brominated PC, up to 50 wt % of the resin composition, Ex7-Ex9 met the flammability, Izod impact and surface resistivity requirements. However, as composition 5 reveals, increasing the brominated PC beyond 50 wt % of the resin composition may significantly deteriorate the Izod impact strength.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

1. An electrostatic dissipative thermoplastic composition comprising:
a. a polycarbonate polymer component comprising a polycarbonate resin, a polysiloxane-polycarbonate copolymer, and a brominated polycarbonate resin;
b. an intrinsically conductive or dissipative polymer or a blend thereof, wherein the intrinsically conductive or dissipative polymer has a surface resistivity less than or equal to 10′ ohms per square (ohm/sq);
c. a flame retardant;
d. an antidripping agent; and
e. an ultraviolet (UV) stabilizer,
wherein the thermoplastic composition is colorable or dyeable.

2. The thermoplastic composition of claim 1, further comprising a catalyst deactivator.

3. (canceled)

4. The thermoplastic composition according to claim 1, wherein the brominated polycarbonate resin is present in an amount from 10 wt. % to 50 wt. % of the total polycarbonate polymer component.

5. The thermoplastic composition according to claim 1, wherein the polysiloxane-polycarbonate copolymer is present in an amount from 1 wt. % to 80 wt. % of the total polycarbonate polymer component.

6. The electrostatic dissipative thermoplastic composition according to claim 1, wherein the brominated polycarbonate resin is present in an amount equal to or less than 50% of the polycarbonate polymer component.

7. The thermoplastic composition according to claim 1, further comprising a radio frequency transparent reinforcing filler comprising a glass fiber or a ceramic fiber.

8. The electrostatic dissipative thermoplastic composition according to claim 1, further comprising a processing aid, the processing aid comprising at least one of a mold release component, a flow modifier component and a process stabilizer.

9. The electrostatic dissipative thermoplastic composition according to claim 1, wherein the flame retardant comprises phosphazene, aryl phosphate, bisphenol A diphosphate, resorcinol bis-diphenylphosphate, bisphenol A diphenyl phosphate, resorcinol diphosphate, or a combination thereof.

10. The electrostatic dissipative thermoplastic composition according to claim 1, wherein the antidripping agent comprises styrene acrylonitrile (SAN) encapsulated polytetrafluoroethylene (PTFE).

11. The electrostatic dissipative thermoplastic composition according to claim 1, wherein the an intrinsically conductive or dissipative polymer comprises a block copolymer, wherein the block copolymer comprises a polyamide-poly(ethylene oxide) (PEO) block copolymer (polyetheresteramide).

12. The electrostatic dissipative thermoplastic composition according to claim 1, further comprising a colorant or a dye.

13. The electrostatic dissipative thermoplastic composition according to claim 1, wherein the flame retardant comprises phosphazene, aryl phosphate, bisphenol A diphosphate, resorcinol bis-diphenylphosphate, bisphenol A diphenyl phosphate, resorcinol diphosphate, or a combination thereof.

14. The electrostatic dissipative thermoplastic composition according to claim 1, further comprising a compatibilizer.

15. The electrostatic dissipative thermoplastic composition according to claim 2, wherein the catalyst deactivator comprises phosphoric acid, phosphorous acid, acidic phosphate salt or octadecyl phosphate.

16. The electrostatic dissipative thermoplastic composition according to claim 1, wherein the thermoplastic composition has one or more of the following properties:
a. electrostatic dissipative properties according to ATEX Directive (94/9/EC) and/or EN 50014 in a potentially explosive atmosphere;
b. a surface resistivity of from about 10⁶ to about 10⁹ ohms/square (Ω/sq) when tested in accordance with ASTM D257;
c. the thermoplastic composition is transparent to radio frequency signals;
d. the thermoplastic composition has a V0 rating at a thickness of about 0.8 millimeter (mm) to about 2.5 mm when tested in accordance with UL 94;
e. the thermoplastic composition does not break under unnotched Izod impact test conditions of ASTM D256 with a pendulum energy of 11 J;
f. the composition has an unnotched Izod impact strength of at least 800 Joule per meter (J/m) at −25° C., when tested in accordance with ASTM D256 with a pendulum energy of 11 J;
g. the thermoplastic composition has a notched Izod impact strength of at least about 200 J/m when tested in accordance with ASTM D256; and
h. the composition is colorable or dyeable.

17. The electrostatic dissipative thermoplastic composition according to claim 1, wherein the thermoplastic composition comprises:
a. from about 40 wt. % to about 85 wt. % polycarbonate component comprising 1 to 15 wt. % of polysiloxane-polycarbonate copolymer and 10 to 50 wt. % brominated polycarbonate based on the total weight of the polycarbonate component;
b. from about 5 wt. % to about 50 wt. % intrinsically conductive/dissipative polymer;
c. from about 3 wt. % to about 25 wt. % flame retardant;
d. from about 0.1 wt. % to about 5 wt. % antidripping agent;
e. from about 0.1 wt. % to about 3 wt. % UV stabilizer; and
f. from about 0.1 wt. % to about 10 wt. % of a colorant or dye
based on the total weight of the electrostatic dissipative thermoplastic composition.

18. The electrostatic dissipative thermoplastic composition according to claim 1, wherein the electrostatic dissipative thermoplastic composition comprises a mold release component in an amount of from about 0.2 wt. % to about 2 wt. %.

19. A molded article formed from the electrostatic dissipative thermoplastic composition of claim 1.

20. A method for making a thermoplastic composition, comprising:
a. combining a thermoplastic polymer, an antidripping agent, an ultraviolet (UV) stabilizer, and optionally a colorant or dye to form a mixture;
b. adding the mixture at a feed throat of an extruder and compounding the mixture in the extruder;
c. adding an intrinsically conductive polymer to the mixture at either the feed throat of the extruder or downstream in the extruder;
d. adding a flame retardant to the mixture into the extruder through the feed throat or through a liquid feed port; and
e. extruding the mixture to form the thermoplastic composition.
